(19) United States
(12) Patent Application Publication
(10) Pub. No.: US 2018/0063064 A1
(43) Pub. Date: Mar. 1, 2018

(54) MODIFYING A MOOD THROUGH SELECTIVE FEEDING OF CONTENT

(71) Applicant: INTERNATIONAL BUSINESS MACHINES CORPORATION, Armonk, NY (US)

(72) Inventors: SANTOSH S. BORSE, OSSINING, NY (US); CHERANELLORE VASUDEVAN, BASTROP, TX (US)

(21) Appl. No.: 15/249,541

(22) Filed: Aug. 29, 2016

(51) Int. Cl. H04L 12/58; H04L 29/08

(52) U.S. Cl. CPC H04L 51/32; H04L 67/10; H04L 67/306

(57) ABSTRACT

Embodiments include method, systems and computer program products for modifying a mood through selective feeding of content. Aspects include obtaining a current mood of a user. Aspects also include obtaining a target mood for the user and receiving a user data to determine a user mood profile for the user. Additionally, aspects include analyzing the mood profile to determine a content to provide to the user based upon the current mood and target mood and providing said content to the user.

### BACKGROUND

The present disclosure relates to modifying a person's mood, and more specifically, to a cognitive system to generate and apply stimuli that modify a person's mood through selective feeding of content.

The mood of a person can affect the person's productivity, creativity, and receptiveness. Certain types of moods can detract or elevate a person's productivity, creativity, and receptiveness in all types of environments. Some moods, such as a depressed mood, may make a person not willing to work with others or may hinder their attention to certain details in their work and life. Other moods, such as an energetic or hopeful mood, may elevate a person's productivity and creativity allowing them to be successful both at work and outside of work.

### SUMMARY

Embodiments include a computer-implemented method for modifying a mood through selective feeding of content. The method includes obtaining a current mood of a user. The method also include obtaining a target mood for the user, receiving a user data to determine a user mood profile for the user, analyzing the mood profile to determine a content to provide to the user based upon the current mood and target mood. The method also includes providing said content to the user.

Embodiments include a computer system for modifying a mood through selective feeding of content, the computer system including a processor, the processor configured to perform a method. The method includes obtaining a current mood of a user. The method also include obtaining a target mood for the user, receiving a user data to determine a user mood profile for the user, analyzing the mood profile to determine a content to provide to the user based upon the current mood and target mood. The method also includes providing said content to the user.

Embodiments also include a computer program product for modifying a mood through selective feeding of content, the computer program product including a non-transitory computer readable storage medium having computer readable program code embodied therewith. The computer readable program code including computer readable program code configured to perform a method. The method includes obtaining a current mood of a user. The method also include obtaining a target mood for the user, receiving a user data to determine a user mood profile for the user, analyzing the mood profile to determine a content to provide to the user based upon the current mood and target mood. The method also includes providing said content to the user.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 illustrates a block diagram of a computer system for use in practicing the teachings herein;

FIG. 4 illustrates a block diagram of a system for modifying a mood through selective feeding of content in accordance with an embodiment; and

FIG. 5 illustrates a flow diagram of a method for modifying a mood through selective feeding of content in accordance with an embodiment.

### DETAILED DESCRIPTION

In accordance with exemplary embodiments of the disclosure, methods, systems and computer program products for modifying a mood through selective feeding of content are provided. In one or more embodiments, methods for selective content delivery to a user to facilitate modifying a mood include receiving both a current mood of a user and a target mood of the user. Additionally, the methods include taking in user data that includes user demographic data, user preferences data, and user historical data to develop a mood profile for the user. In one or more embodiments, the method includes analyzing the mood profile to determine a content to provide to the user to modify the user's current mood to the identified target mood. This content can be provided in the form of music, videos, new articles, images, fictional or non-fictional content, inspirational speeches or words, and the like.

Accordingly, one or more embodiments of the present invention provide systems and methodologies that bridge a gap between a current mood and a target mood. Based at least in part on the current mood and the target mood, embodiments of the present invention decide the type of content, or more specifically, the type of content feed to deliver to an individual to achieve the target mood. The operations utilized by embodiments of the present invention to switch from a current mood to a target mood are not generic steps. The operations according to the described embodiments utilize a cognitive system to analyze the individual's profile and preferences in order to tailor and deliver a mood altering content feed. In one or more embodiments, the cognitive system utilizes a machine learning technique to analyze mood changes tied to the content feed to better deliver the content in the future. Content type, such as, for example, music versus images, can be as influential as the content itself. Content type is determined by an individual's profile and preferences that are in turn individually tailored to the individual to achieve a target mood. In one or more embodiments, this invention can be tied to worker's productivity and creativity. The invention can utilize detection and then correction of a worker's mood, such as negative mood, and take individually tailored steps to transition from a negative mood to a positive mood through the delivery of content.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

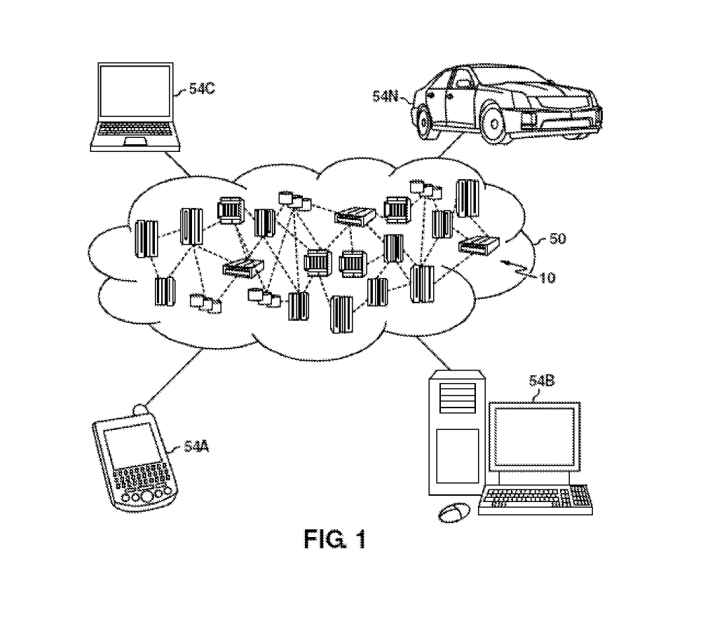

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

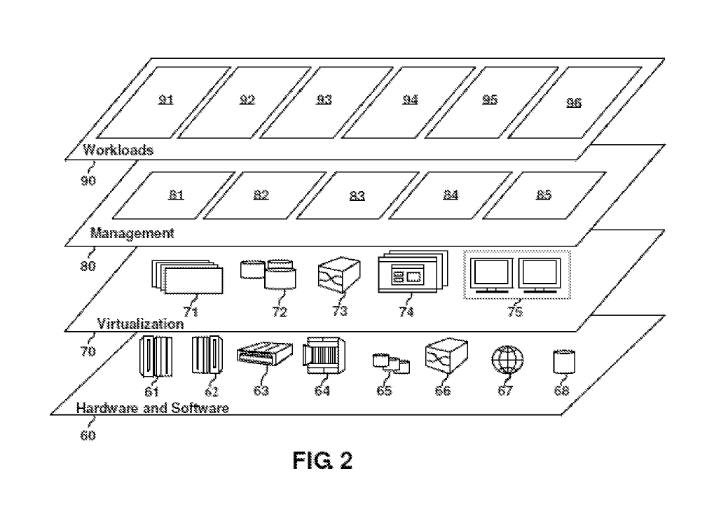

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the generation and application of stimuli for modifying a person's mood 96.

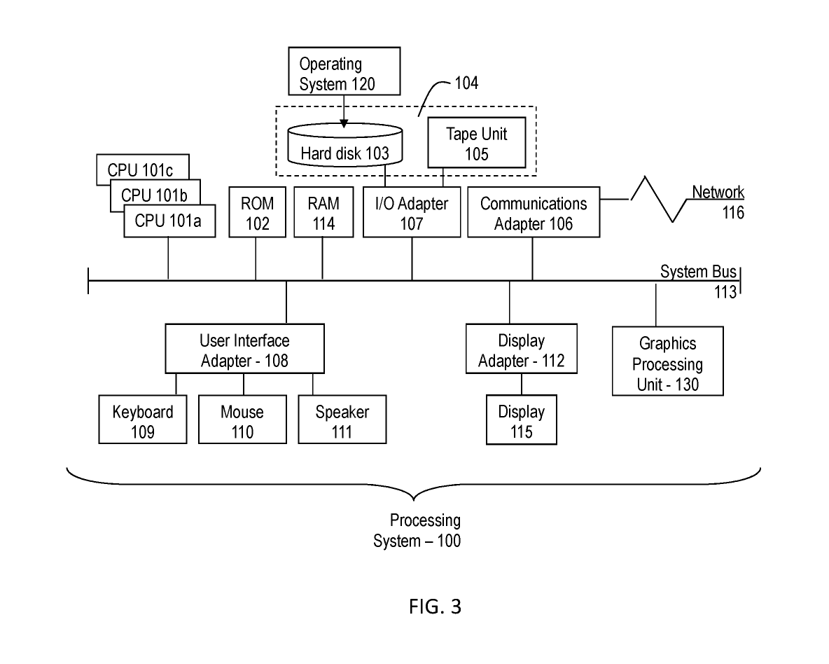

Referring to FIG. 3, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 3 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

In exemplary embodiments, the processing system 100 includes a graphics processing unit 130. Graphics processing unit 130 is a specialized electronic circuit designed to manipulate and alter memory to accelerate the creation of images in a frame buffer intended for output to a display. In general, graphics processing unit 130 is very efficient at manipulating computer graphics and image processing and has a highly parallel structure that makes it more effective than general-purpose CPUs for algorithms where processing of large blocks of data is done in parallel.

Thus, as configured in FIG. 3, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system coordinate the functions of the various components shown in FIG. 3.

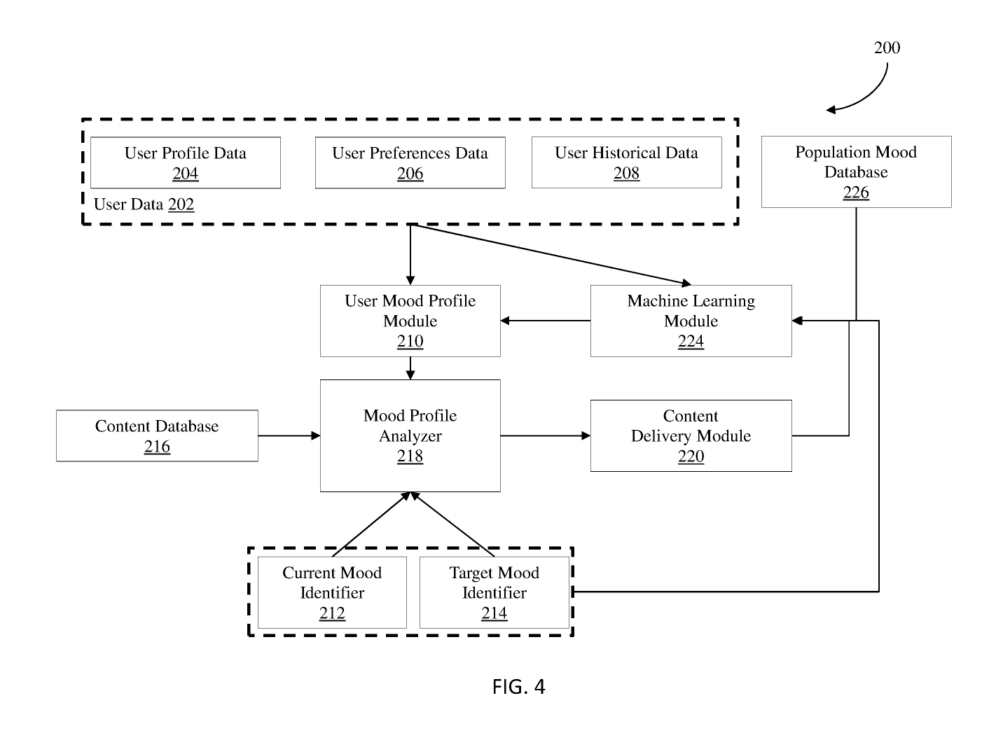

FIG. 4 is a block diagram illustrating a system 200 for modifying a mood according to one or more embodiments. As shown in FIG. 4, the system 200 includes user data 202, a user mood profile module 210, a current mood identifier 212, a target mood identifier 214, a content database 216, a mood profile analyzer 218, a content delivery module 220, a machine learning module 224, and a population mood database 226.

In one or more embodiments, the user data 202 includes a user profile data 204, user preferences data 206, and user historical data 208. The user profile data 204 includes information about the user of the system 200 that relates to the user's demographics, the user's vocations and occupations, the user's interests and activities. The user preferences data 206 includes information about the user of the system 200 that relates to preferences for types of media content such as music, images, books, magazines, websites, news articles, and the like. Additionally, the user historical data 208 includes information on a user of the system 200 that relates to the user's past selection or past consumption of media content. The user data 202 is fed into a user mood profile module 210 to determine a mood profile of the user. The mood profile of the user includes data about the user which shows how the mood of a user can be influenced by certain types of content based upon the user data 202. The mood profile of the user determines the selection of targeted content that tends to influence a mood of the user from current mood to a target mood. A mood can be one of, but not limited to, sad, happy, angry, and annoyed.

In one or more embodiments, the mood profile analyzer 218 receives a current mood of a user from the current mood identifier 212 and a target mood of the user from the target mood identifier 214. The current mood identifier 212 and the target mood identifier 214 monitor and update the current and target mood of the user on an ongoing basis. These identifiers (212, 214) also monitor and update on any intermediate mood changes of a user. The mood profile analyzer 218 also receives the mood profile of the user from the user mood profile module 210. Based upon the current and target mood, the mood profile analyzer 218 analyzes the mood profile to determine content for the user to achieve a change from the current mood to the target mood. The content is received from a content database 216. The content database 216 can be a music library, an image library, a news database, a social media feed, a video library, and the like. The content database 216 can be taken from the internet or a computer network that stores accessible content.

In one or more embodiments, the mood profile analyzer 218 identified content from the content database 216 that will achieve the target mood of the user based upon the mood profile of the user. The content delivery module 220 then delivers the content to the user. The content delivery module 220 determines the frequency and time of delivery of the selected content from the content database 216. The delivery of the content can be in many forms including, for example, a social network content feed, a music playlist, a video playlist, a news or website article feed and the like. For example, based upon the target mood, the system 200 can modify the incoming musical selection in a music playlist or can modify the types of news articles or website articles that appear in the user's social media network feed. In one or more embodiments, the system 200 can modify the order of content being delivered to the user to achieve the target mood for the user.

In one or more embodiments, the system 200 includes a machine learning module 224 and population mood database 226. The machine learning module 224 employs a content classification learning model to analyze the content delivered to the user via the content delivery module 220. The machine learning module 224 also employs a model that helps select the right type of feeds for the different content and develops rules and relationships that tie feed content types and objectives profiled for a user. The machine learning module 224 correlates the type of feed that has been previously sent to a user and monitors the reaction or effect on the user and updates the rule and relationships. The population mood database 226 contains information about user data related to a population of users and how mood profiles are created and how content is selected for other users. The population mood database 226 supplies information to the machine learning module 224 to adjust the user mood profile. For example, if a user population of a individuals between the age of 30 years old to 40 years old who are sports enthusiasts have a mood transition based upon delivering music content related to a favorite sports team, such as a fight song, then the machine learning module 224 will incorporate this data into the user mood profile based upon the user data 202.

The machine learning module 224 has access to the current mood of the user via the current mood identifier 212 in real time to adjust the delivered content to achieve the target mood transition. As the machine learning module 224 receives mood transitions based upon content deliver, the model developed by the machine learning module 224 is improved over time as it gains experience influencing a user's mood transition. In one or more embodiments, the target mood can be achieved by one or more intermediate mood transitions. For example, a current mood such as sad may be intermediately transitioned to excited or energized before being transitioned to the target mood of happy. As the machine learning module 224 gains experience over time with influencing a user's mood, the user mood profile module 210 can update the user mood profile based upon the machine learning module 224.

In one or more embodiments, the current mood identifier 212 can obtain a current mood of the user from various sensors associated with a user such as biometric and wearable sensors for determining current mood of the user. In addition to employing biometric and wearable sensors, the current mood identifier 212 can determine a current mood for the user based on the user data 202.

In one or more embodiments, the system 200 obtains a current mood of a user and a target mood of a user and determines content to transition the current mood of the user to the target mood of the user. For example, if a user is in a depressed state as obtained by the current mood identifier 212, the target mood identifier 214 can determine a target mood to transition the user. The target mood identifier 214 can obtain a target mood from input from the user, from user data 202 which shows what mood the user is most productive, or from a host of other mood identifying techniques such as obtaining data from various sensors associated with a user including biometric and wearable sensors for determining the current mood of the user. In addition to employing biometric and wearable sensors, a personalized mood category value for a user based on the user profile data (e.g., age, gender, geo location), recent mood transitions, feedback from recent mood transition, recently delivered content, and analyzing the content of recent post made by that users can be included to determine either the current mood or a target mood for the user. Further, a machine learning processes, through the machine learning module 224, can be used to improve accuracy of determination of selective content to deliver to a user to transition a current mood of a user to a target mood. For example, one or more machine learning techniques such as, but not limited to, pattern recognition, supervised learning, unsupervised learning, and clustering can be utilized. In this example, the target mood is set for a “hopeful mood.” The user data 202 discloses that the user is an “avid” sportsman, the user is in his mid-20 s, and he likes to travel and enjoys outdoor activities. Based upon the user data, a mood profile for the user is generated which is analyzed by the mood profile analyzer 218. Based upon the mood profile, the mood profile analyzer 218 determines a selection of categories of content for the user. For example, the content can be a social media feed and displays a priority for each of the different categories of content. For transitioning the user from a depressed mood to a hopeful mood, content, such as pictures and videos of inspiring sports comebacks can be provided. Additionally, songs such as a victory march for a preferred sports team can be played. The preferred sports team can be found in the user data 202. Additionally, the content can include inspirational speeches delivered to the user's social networking feed.

In one or more embodiments, the delivery of content to the user can also include a user input that can indicate whether the user approves of the content or disapproves of the content. This user input can be fed back into the user's historical data which can update the user's mood profile to indicate that the content provided was or was not accepted by the user. The user's mood profile can be updated utilize machine learning algorithms based upon the type of content provided and the user input or any changes in the user's mood as a result of the content being provided. For example, if the target mood is not achieved when playing a certain type of music or a certain type of video, the mood profile can be adjusted to remove the content type or the subject of the content from future usage.

In one or more embodiments, the content delivery module 220 can be a smart system that delivers content to a user in the home, office, car or any other location for a user. For example, when transitioning from one mood to another, the content delivery module 220 could adjust environmental conditions such as lighting in a room, temperature, volume of music, and the like. Additionally, the content delivery module 220 can modify or adjust social media feeds, music playlists, online podcasts, and other online media to transition a user's mood.

In one or more embodiments, the system 200 gathers historical data 208 that can be used for clustering the user with other users of the system 200 into categories to provide better targeted content by utilizing machine learning techniques described above.

In one or more embodiments, the system 200 can be utilized by doctors or psychologists to develop a treatment program for a user.

In one or more embodiments, the system 200 continuously monitors the current mood of the user to determine whether a transition to a target mood is achieved. As content is being delivered to the user via the content deliver module 220, the system monitors the mood of the user and updates the mood profile for the user based upon the transition of the user's mood. For example, if video content over musical content transitions a user to a target mood in less time, then the mood profile is updated to reflect the effectiveness of a content category over another content category.

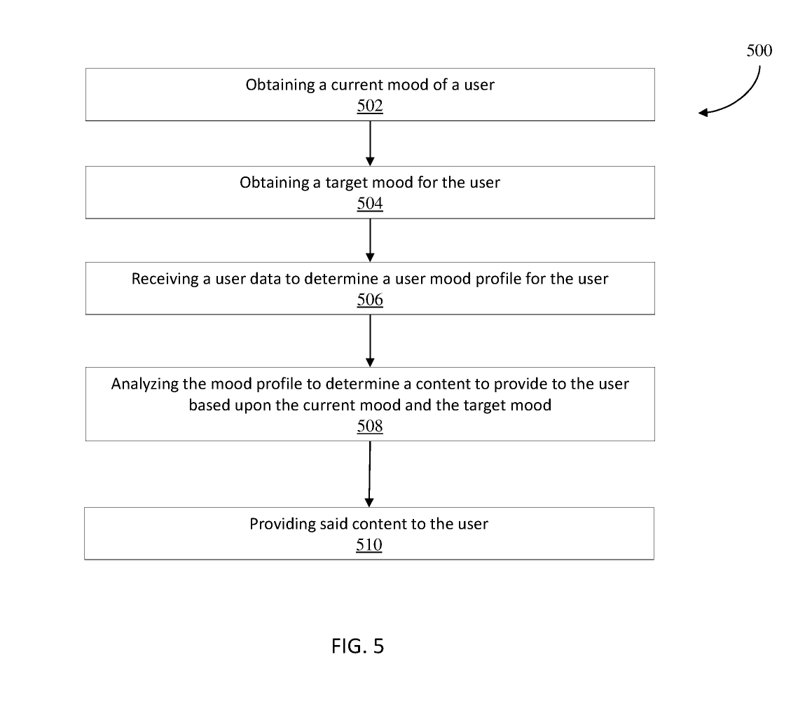

FIG. 5 illustrates a flow diagram of a method 500 for modifying a mood according to one or more embodiments. As shown in block 502, the method 500 includes obtaining a current mood of a user. Next, at block 504, the method 500 includes obtaining a target mood for the user. The method 500 includes receiving a user data to determine a user mood profile for the user, as shown in block 506. At block 508, the method 500 includes analyzing the mood profile to determine a content to provide to the user based upon the current mood and the target mood. Next, at block 510, the method 500 includes providing said content to the user.

Additional processes may also be included. It should be understood that the processes depicted in FIG. 5 represent illustrations, and that other processes may be added or existing processes may be removed, modified, or rearranged without departing from the scope and spirit of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting-data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for modifying a mood through selective feeding of content, the method comprising:
obtaining a current mood of a user;
obtaining a target mood for the user;
receiving a user data to determine a user mood profile for the user;
analyzing the mood profile to determine a content to provide to the user based upon the current mood and target mood; and
providing said content to the user.

2. The method of claim 1, wherein the providing said content is performed in a social networking content feed.

3. The method of claim 1, wherein the user data comprises:
a user profile, a user preferences, and a user history.

4. The method of claim 1, wherein the user mood profile is updated based upon input from the user.

5. The method of claim 1, further comprising:
receiving feedback from the user related to the content; and
updating the user mood profile based upon the feedback from the user.

6. The method of claim 1, wherein the target mood of the user is obtained by an input from the user.

7. The method of claim 1, wherein the current mood of the user is obtained via a sensor coupled to an electronic device.

8. The method of claim 1, further comprising:
monitoring the current mood of the user; and
updating the user mood profile for the user based upon deviations of the current mood of the user.

9. The method of claim 1, further comprising:
monitoring the current mood of the user; and
updating the user mood profile for the user based upon a lack of deviation of the current mood of the user.

10. The method of claim 1, wherein the content to provide to the user is drawn from a computer network.

11. A computer system for modifying a mood through selective feeding of content, the computer system including a processor, the processor configured to perform a method comprising:
obtaining a current mood of a user;
obtaining a target mood for the user;
receiving a user data to determine a user mood profile for the user;
analyzing the mood profile to determine a content to provide to the user based upon the current mood and target mood; and
providing said content to the user.

12. The system of claim 11, wherein the providing said content is performed in a social networking content feed.

13. The system of claim 11, wherein the user mood profile is updated based upon input from the user.

14. The system of claim 11, further comprising:
receiving feedback from the user related to the content; and
updating the user mood profile based upon the feedback from the user.

15. The system of claim 11, wherein the target mood of the user is obtained by an input from the user.

16. The system of claim 11, wherein the current mood of the user is obtained via a sensor coupled to an electronic device.

17. The system of claim 11, wherein the content to provide to the user is drawn from a computer network.

18. A computer program product for modifying a mood through selective feeding of content, the computer program product including a non-transitory computer readable storage medium having computer readable program code embodied therewith. The computer readable program code including computer readable program code configured to perform a method comprising:
obtaining a current mood of a user;
obtaining a target mood for the user;
receiving a user data to determine a user mood profile for the user;
analyzing the mood profile to determine a content to provide to the user based upon the current mood and target mood; and
providing said content to the user.

19. The computer program product of claim 18, wherein the providing said content is performed in a social networking content feed.

20. The computer program product of claim 18, further comprising:
receiving feedback from the user related to the content; and
updating the user mood profile based upon the feedback from the user.
